(19) United States
(12) Patent Application Publication
(10) Pub. No.: US 2010/0171313 A1
(43) Pub. Date: Jul. 8, 2010

(54) Under the bottom ocean wave energy converter

(76) Inventor: Glen Edward Cook, Simpson, PA (US)

Correspondence Address: Glen Edward Cook, 89 Prospect Street, Simpson, PA, 18407, US

(21) Appl. No.: 12/655,150

(22) Filed: Dec. 21, 2009

Related U.S. Application Data
(60) Provisional application No. 61/204,580, filed on Jan. 8, 2009.

(51) Int. Cl. F03B 13/22

(52) U.S. Cl. 290/53

(57) ABSTRACT

Disclosed is a device to convert the energy of ocean waves into electricity. The device has a barrel shaped body mounted on legs on the ocean floor. The body extends from below the trough of a wave at low tide to a height above the largest wave at high tide. There is a vented top and a hole at the bottom of the body. The hole in the bottom is smaller than the body to cause the water flow to speed up as it passes the turbine. A turbine generator is mounted at the hole in the bottom of the body. When the crest of a wave passes the device, water flows up into the body through the hole in the bottom spinning the turbine generator. As the trough of the wave passes the device the water flows out of the bottom spinning the turbine generator producing electricity.

### CROSS-REFERENCE TO RELATED APPLICATIONS

This patent application is related to the U.S. Provisional Patent Application Ser. No. 61/204,580 dated Jan. 8, 2009 titled “Under The Bottom Ocean Wave Energy Converter” and assigned to the invention.

### FEDERALLY SPONSORED RESEARCH

None.

### SEQUENCE LISTING

None.

### BACKGROUND

This invention relates to a device to convert ocean and other types of water driven waves into electricity. With the cost of oil becoming higher every day, the problems caused by global warming and the ever growing need for power, a means of extracting energy from solar power is needed. When the sun hits the earth it warms the earth creating wind. As the wind blows over water it creates waves. The waves are concentrated solar power.

There have been many devices made to convert the ocean waves into electricity; however, few can compete with the cost of coal.

There are many types of wave converters called the “over the top” type energy converters. These devices have a wall or dam that will allow the top of the wave to go over it, then allow the water to flow through a turbine driven generator and back into the ocean. There are two major problems with this type of generator. The wall height must be adjusted to the wave height and the changing tide. The second problem is half the wave height is used to get the water over the top and the other half is used to produce head pressure. This reduces the available power by fifty percent.

The Under The Bottom Ocean Wave Energy Converter is, by design, self adjusting to the wave height and tide height and uses the full height of the wave to create higher head pressure. None of the wave height is used to allow the water to flow over the top and into the device. The Under The Bottom Ocean Wave Energy Converter allows the water to enter from the bottom. The Under The Bottom Ocean Wave Energy Converter use the full height of the waves by extending their vertical pipes from below the lowest wave trough at low tide to above the highest wave crest at high tide. The Under The Bottom Ocean Wave Converter is very low cost to build, install and maintain.

### SUMMARY OF THE INVENTION

In view of the proceeding problems and high cost per kilowatt hour of electricity produced, the Under The Bottom Ocean Wave Energy Converter provides a more cost efficient device.

The present invention provides a device comprising of a barrel shaped body mounted in a vertical position on legs in the ocean. The top extends to a position above the highest wave at high tide. The top would be vented.

The bottom would have an opening about half the diameter of the body. A propeller or turbine generator would be mounted in the hole.

As the wave passes the generator water will flow up into and down out of the body spinning the turbine and generator thus producing electricity.

### DRAWINGS

FIG. 1 is a side view with a cutout view of the turbine generator.

FIG. 2 is a top view.

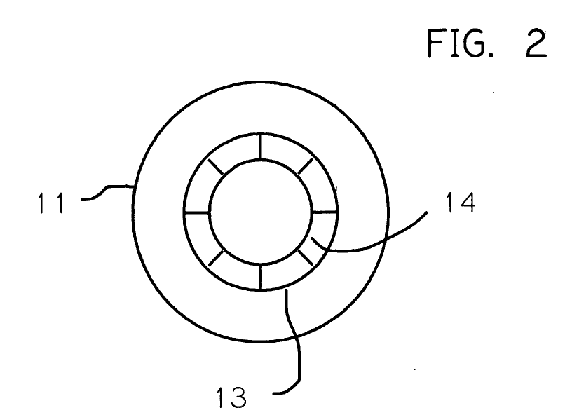

FIG. 3 is a bottom view

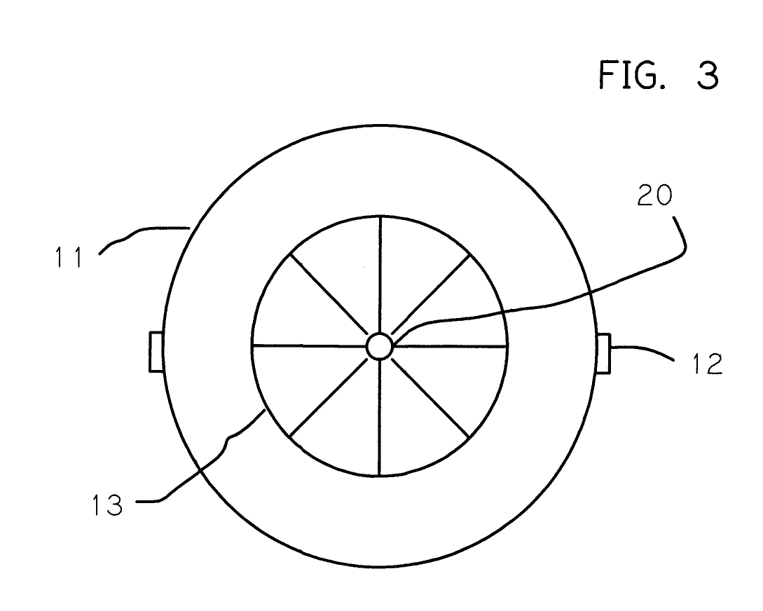

FIG. 4 is a top view showing the top of the generator connected to a large pulley connected to a second pulley on the generator with a belt connecting the two pulleys.

FIG. 5 is a cast structure as an under the bottom generator body and a sea wall modular section

### DRAWING

### Reference Numerals

11 body
12 legs
13 propeller/turbine
14 generator
15 gearbox
16 bottom
17 large pulley
18 small pulley
19 belt
20 drive shaft

### DETAILED DESCRIPTION

The present invention comprises the main barrel shape body 11 in a vertical position with legs 12 mounted to the body 11 to mount it on the ocean floor. The body 11 could be round, oval or any shape. Round or oval would be best. The body 11 would have a bottom with a round hole in the center about half the diameter of the body 11. The body 11 would be open or vented at the top.

There would be a propeller or turbine 13 with a diameter slightly smaller than the hole in the bottom of the body 11.

A generator 14 would be mounted and connected to the turbine 13.

### Operation

When the Under The Bottom Ocean Wave Energy Converter is mounted on the ocean floor and the crest of a wave is passing, water will flow up through the hole in the bottom 16 and spin the propeller/turbine 13 and the generator 14 producing electricity.

When the Under The Bottom Ocean Wave Energy Converter is mounted on the ocean floor and the trough of a wave is passing, water will flow down and out through the hole in the bottom 16 and spin the propeller/turbine 13 and the generator 14 producing electricity.

Because the hole in the bottom 16 is only about half the diameter of the body 11 the flow of water flowing into or out of the body 11 would be restricted. This would cause the water level outside the body 11 to rise or fall quicker than the water level inside the body 11 causing a difference in water level. This difference in water level would cause a difference in pressure thus causing the water to flow faster through the hole in the bottom 16 and past the turbine 13. This will cause the turbine 13 to spin faster with more torque thus producing more power.

The water flowing into the body 11 will fill the body but never flow through.

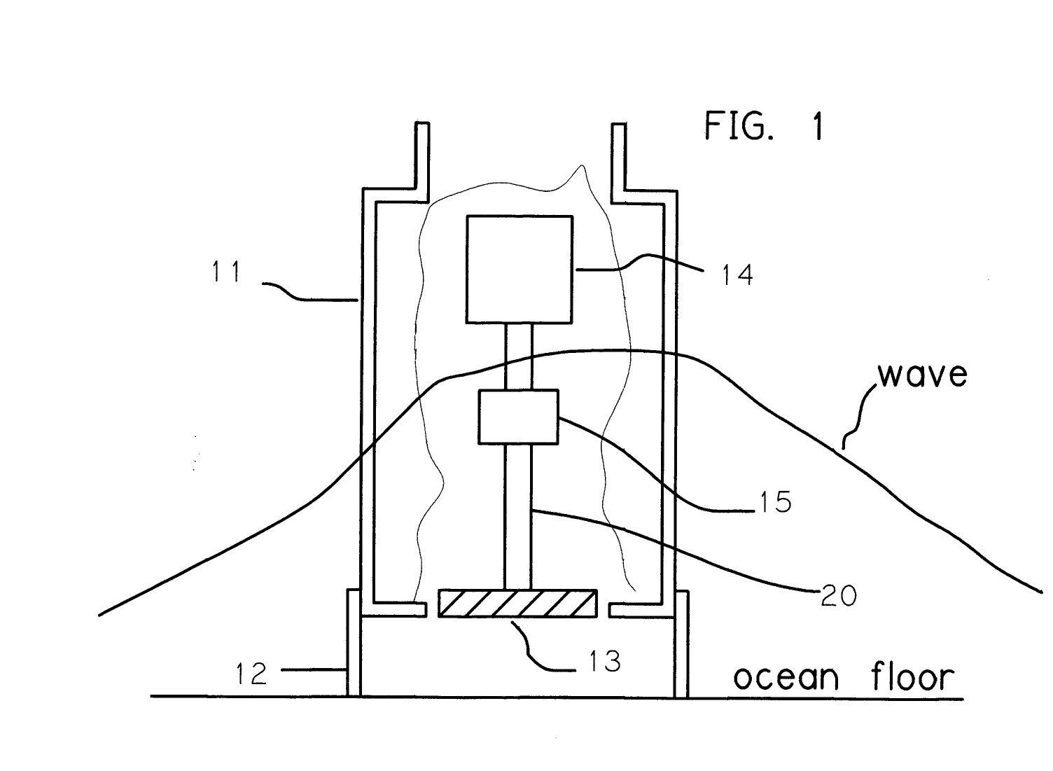

In FIG. 1 we see a gearbox 15 connected with a drive shaft 20 between the turbine 13 and the generator 14 to adjust the speed of the generator 14.

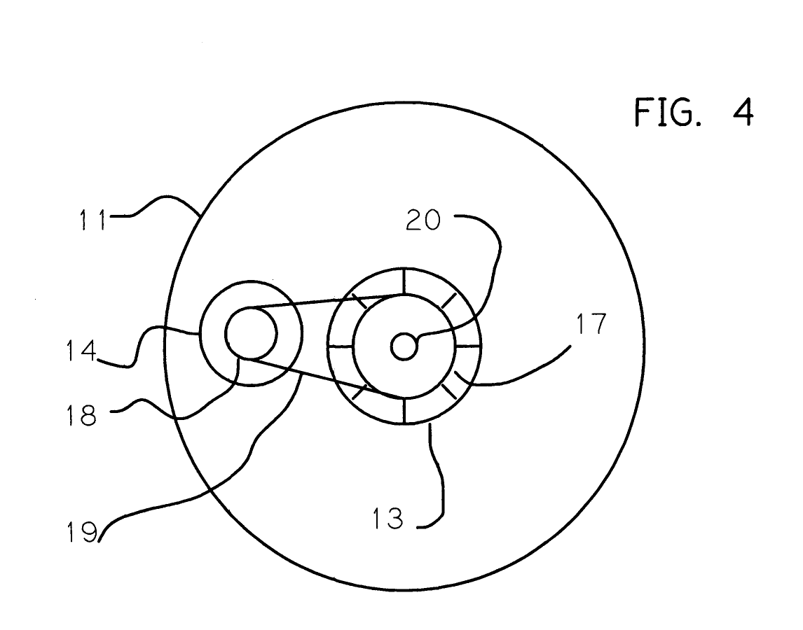

In FIG. 4 we see a belt drive where the drive shaft 20 has a large pulley 17 mounted and connected with a belt 19 to a small pulley 18 mounted on the generator 14.

The turbine 13 could have fixed blades or movable blades or other means to cause it to spin in one direction regardless of weather the water was moving up or down through the turbine.

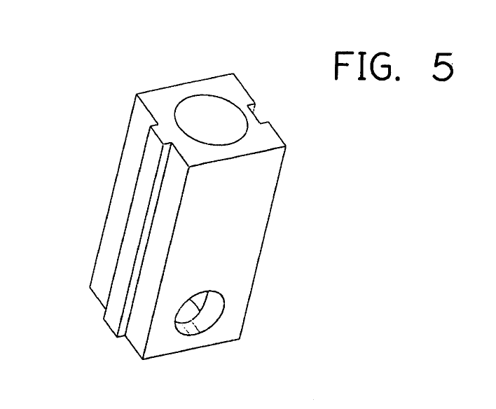

In FIG. 5 we see a cement casting forming the body 11 and a structure for building a sea wall with an Under The Body Generator inside. The casting would be best built of cement but could be of other materials. The casting has a vertical hole down the center where a generator 14, drive shaft 20 and a turbine 13 could be mounted. A bottom 16 with a smaller hole than the body could be installed below the turbine 13 or could be included in the casting. There would be a horizontal inlet/outlet hole below the bottom 16 to allow the water to flow into and out of the generator. This would be needed because the structure bottom would be submerged into the ocean floor. The structure could be an interlocking building block as shown in FIG. 5 or could be round, square or other shape. The casting may include one vertical hole to hold one Under the Bottom Generator or have many holes to hold many generators. These cast structures could be used as sea walls, bridge pillars or other useful structures.

What I claim as my invention is:

1. A device for converting ocean waves in a wave-driven water body into electricity, comprising:
a. a tube or pipe mounted horizontally above the water surface with the bottom extending down below the water surface,
b. a bottom with a hole in the center mounted at the bottom of said pipe,
c. a turbine mounted in said hole,
d. a generator mounted above and connected to said turbine with a drive shaft,
whereby the passing waves will cause water to flow up and down through said hole and into said pipe causing said turbine to spin and turn said generator creating electricity.

2. The device for converting ocean waves in a wave-driven water body into electricity of claim 1, wherein a gearbox is mounted between said turbine and said generator.

3. The device for converting ocean waves in a wave-driven water body into electricity of claim 1, wherein the said turbine has movable blades that allow it to spin in only one direction regardless of weather the water is flowing into or out of said pipe.

4. A device for converting ocean waves in a wave-driven water body into electricity, comprising:
a. a tube or pipe mounted horizontally above the water surface with the bottom extending down below the water surface,
b. a bottom with a hole in the center mounted at the bottom of said pipe,
c. a turbine mounted in said hole,
d. a pulley mounted above and connected to said turbine with a drive shaft,
e. a second pulley connected to said pulley with a belt,
f. a generator connected to said second pulley,
whereby the passing waves will cause water to flow up and down through said hole and into said pipe causing said turbine to spin and turn said first pulley and said belt turning said second pulley causing said generator to turn creating electricity.

5. A device for converting ocean waves in a wave-driven water body into electricity, comprising:
a. a cast structure that could be used as a building block for a sea wall, bridge pillar or other useful structure with a vertical hole down the center and a horizontal hole near the bottom of said structure connecting the said horizontal hole to the ocean, mounted horizontally above the water surface with the bottom extending down below the water surface,
b. a bottom with a hole in the center mounted at the bottom of said vertical hole in the structure and above said horizontal hole,
c. a turbine mounted in said hole,
d. a generator connected to said turbine with a drive shaft,
whereby the passing waves will cause water to flow up and down through said hole and into said vertical hole causing said turbine to spin and turn said generator creating electricity.
